(19) United States
(12) Patent Application Publication
(10) Pub. No.: US 2006/0215076 A1
(43) Pub. Date: Sep. 28, 2006

(54) Selective light transmitting and receiving system and method

(76) Inventor: John H. Karim, Cypress, CA (US)

Correspondence Address: CROWELL & MORING LLP;INTELLECTUAL PROPERTY GROUP, P.O. BOX 14300, WASHINGTON, DC, 20044-4300, US

(21) Appl. No.: 11/087,132

(22) Filed: Mar. 22, 2005

(51) Int. Cl. G02F 1/1333

(52) U.S. Cl. 349/86

(57) ABSTRACT

A selective light transmitting and receiving system for the reduction of glare and unwanted light. The selective light system includes a light source, a first polarized filter adapted to polarize light emanating from the light source in a first polarization orientation, a second polarized filter adapted to perform polarized filtering of received light in a second polarization orientation, and a light receiving device adapted to receive the filtered light. The selective light system may be incorporated into a vehicle system, a roadway system, a camera or video system, a microscope system, a night vision device, a hard hat lighting system, and a stage lighting system.

### FIELD OF THE INVENTION

This invention relates generally to selective light transmitting and receiving systems and methods, and in particular, to selective light transmitting and receiving systems and methods that use polarized filters to remove unwanted glare and other light emissions.

### BACKGROUND OF THE INVENTION

Safety is an important consideration in the design of motor vehicles, such as cars, trucks, and motorcycles. For example, seat belts are now standard and required in many vehicles. Also, driver and even passenger air bags are also standard and required in many vehicles. In addition, the vehicle frame and component placement are now further design to improve the safety of the driver and passengers.

Of particular interest is the safety consideration relevant to the driver's visibility of the road. Often during driving, a driver encounters many adverse light sources that impede the driver's visibility of the road. For example, during daytime driving, a driver may encounter glare directly from the Sun or by way of reflective objects. During nighttime driving, a driver may encounter glare directly from the headlights of on-coming vehicles or by way of reflective objects, glare from the driver's own vehicle headlights by way of reflective objects, and roadway lights.

In the past, attempts have been made to reduce glare and unwanted light for a driver. One such attempt is the use of certain types of polarized filters to reduce glare associated with the headlights of on-coming cars. The following describes an exemplary illustration of such prior attempt and discusses the drawbacks associated with that solution.

FIG. 1 illustrates a side view of a prior art vehicle glare reduction system 100. The system 100 consists of a first vehicle 110 including a headlight 112, a first polarized filter 114 situated in front of the headlight 112, and a second polarized filter 116 situated in front of the driver 120 of the first vehicle 110. The system 100 further consists of a second vehicle 140 including a headlight 142, a first polarized filter 144 situated in front of the headlight 142, and a second polarized filter 146 situated in front of the driver 150 of the second vehicle 140.

The first polarized filter 114 of the first vehicle 110 is configured to polarize light emanating from the headlight 112 in a +45 degree orientation. The second polarized filter 116 of the first vehicle 110 is configured to perform polarize filtering of the incident light towards the driver 120 in a +45 degree orientation. Similarly, the first polarized filter 144 of the second vehicle 140 is configured to polarize light emanating from the headlight 142 in a +45 degree orientation. The second polarized filter 146 of the second vehicle 140 is configured to perform polarize filtering of the incident light towards the driver 150 in a +45 degree orientation.

From the perspective of the driver 120 of the first vehicle 110, the light 148 emanating from the headlight 142 by way of the polarized filter 144 is polarized in a −45 degree orientation. The polarized filter 116 in front of the driver 120, being polarized in the +45 degree orientation, blocks substantially most of the light 148 emanating from the second vehicle 140. The reason for this is that the polarization of the polarized filter 116 is substantially orthogonal to that of the incident light 148 emanating from the second vehicle 140. Thus, the prior vehicle glare reduction system 100 provides protection from glare emanating from on-coming vehicles.

However, the vehicle glare reduction system 100 does not protect well against glare emanating from the driver's own vehicle. For example, from the perspective of the driver 120 of the first vehicle 110, the light 118a emanating from the headlight 112 by way of the polarized filter 114 is polarized in a +45 degree orientation. When the light 118a strikes a reflective object 130, the reflected light 118b is also polarized in a +45 degree orientation. In other words, the polarization of the incident light and the reflected light are substantially the same. In this case, however, the polarized filter 116 in front of the driver 120 does not significantly block the reflected light 118b since their polarization are substantially the same. Thus, the driver 120 is susceptible to impaired vision due to glare emanating from its own vehicle headlights.

As is discussed in further detail below, there are many other situations where certain light sources may adversely affect an intended operation or performance.

### SUMMARY OF THE INVENTION

An aspect of the invention relates to a vehicle glare reduction system comprising a light source; a first polarized filter adapted to polarize light emanating from the light source in a first orientation, wherein the first orientation is substantially horizontal or substantially vertical; and a second polarized filter situated in front of a driver's viewing area and adapted to perform polarize filtering of the incoming light in a second orientation substantially orthogonal to the first orientation of the first polarized filter.

Another aspect of the invention relates to a roadway glare reduction system, comprising a road; a plurality of first polarized filter panels situated along the road and configured to polarize light emanating from the Sun and/or other light sources; and a plurality of roadway lights for lighting the road, wherein the roadway lights respectively comprise polarized filters adapted to polarize light emanating respectively from the roadway lights.

Another aspect of the invention relates to a camera or video system, comprising a light source, a first polarized filter configured to polarize light emanating from the light source, a second polarized filter adapted to perform polarized filtering on a received light; and a light sensitive device adapted to receive the filtered light.

Another aspect of the invention relates to a microscope system, comprising a light source, a first polarized filter configured to polarize light emanating from the light source, a second polarized filter adapted to perform polarized filtering on a received light, and an objective lens adapted to receive the filtered light.

Another aspect of the invention relates to a night vision device, comprising an infrared light source, a first polarized filter configured to polarize infrared light emanating from the infrared light source, a second polarized filter adapted to perform polarized filtering on a received infrared light, and an infrared light sensitive device adapted to receive the filtered light.

Another aspect of the invention relates to a hard hat lighting system comprising a hard hat, a light source attached to the hard hat, and a first polarized filter adapted to polarize light emanating from the light source. The hard hat lighting system may further comprise an eye wear including a second polarized filter adapted to perform polarized filtering of a received light.

Another aspect of the invention relates to a stage lighting system, comprising a stage light source, and a first polarized filter adapted to polarize light emanating from the stage light source. The stage lighting system may further comprise a second polarized filter adapted to further polarize light emanating from the stage light source.

Other aspects, features, and techniques of the invention will be apparent to one skilled in the relevant art in view of the following detailed description of the invention.

### BRIEF DESCRIPTION OF THE DRAWINGS

FIG. 1 illustrates a side view of a prior art vehicle glare reduction system;

FIG. 2A illustrates a side view of an exemplary vehicle glare reduction system in accordance with an embodiment of the invention;

FIG. 2B illustrates a block diagram of an exemplary vehicle glare reduction control system in accordance with another embodiment of the invention;

FIG. 2C illustrates a block diagram of another exemplary vehicle glare reduction control system in accordance with another embodiment of the invention;

FIG. 3 illustrates a perspective view of an exemplary roadway glare reduction system in accordance with another embodiment of the invention;

FIG. 4A illustrates a side view of an exemplary camera system in accordance with another embodiment of the invention;

FIG. 4B illustrates a block diagram of an exemplary camera control system in accordance with another embodiment of the invention;

FIG. 4C illustrates a block diagram of another exemplary camera control system in accordance with another embodiment of the invention;

FIG. 5A illustrates a side view of an exemplary microscope system in accordance with another embodiment of the invention;

FIG. 5B illustrates a block diagram of an exemplary microscope control system in accordance with another embodiment of the invention;

FIG. 5C illustrates a block diagram of another exemplary microscope control systems in accordance with another embodiment of the invention;

FIGS. 6A and 6B illustrate front and side views of an exemplary night-vision binocular system in accordance with another embodiment of the invention;

FIG. 6C illustrates a block diagram of an exemplary night-vision binocular control system in accordance with another embodiment of the invention;

FIG. 6D illustrates a block diagram of another exemplary night-vision binocular control systems in accordance with another embodiment of the invention;

FIG. 7 illustrates a side view of an exemplary hard hat lighting system in accordance with another embodiment of the invention;

FIG. 8A illustrates a side view of an exemplary performing stage lighting system in accordance with another embodiment of the invention; and

FIG. 8B illustrates a side view of another exemplary performing stage lighting system in accordance with another embodiment of the invention.

### DETAILED DESCRIPTION OF THE PREFERRED EMBODIMENTS

I. Vehicle Glare Reduction System

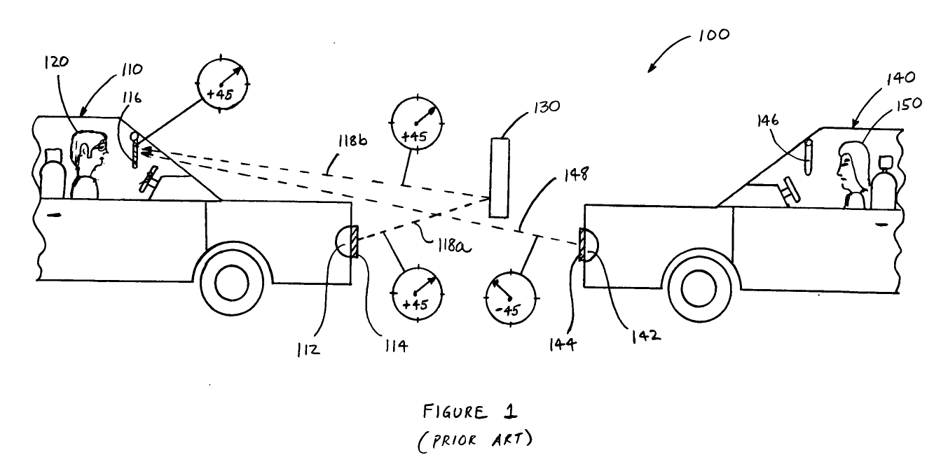

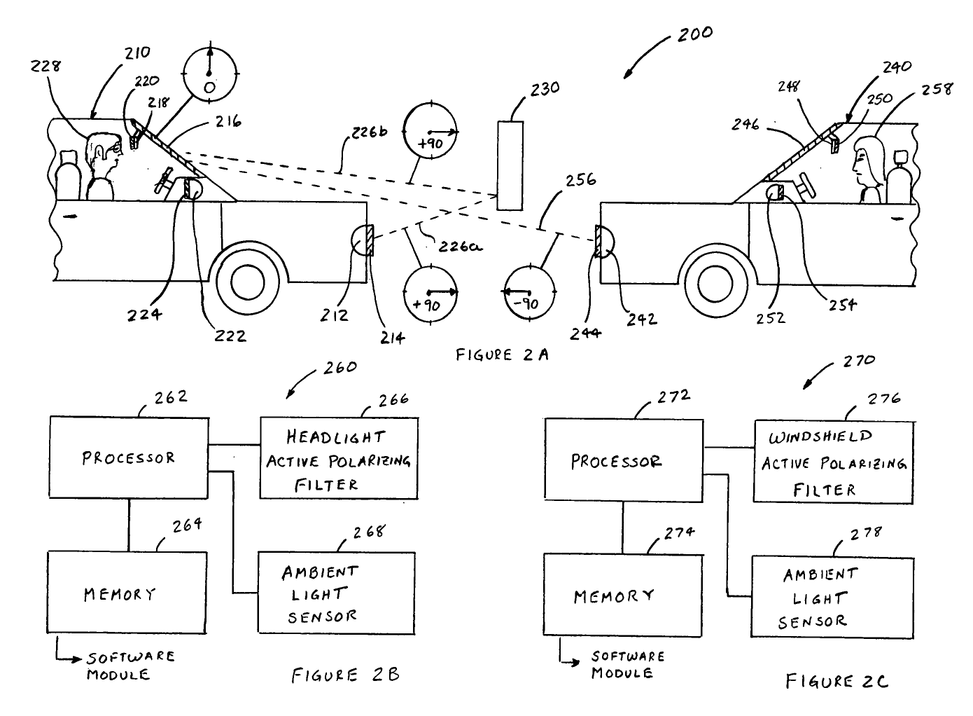

FIG. 2A illustrates a side view of an exemplary vehicle glare reduction system 200 in accordance with an embodiment of the invention. The system 200 comprises a first vehicle 210 including a headlight 212 and a first polarized filter 214 situated in front of the headlight 212. It shall be understood that there may be such a polarized filter 214 in front of each other headlight of the first vehicle 210. The first vehicle 210 further comprises a second polarized filter 216 situated in front of the driver 228 of the first vehicle 210. In this example, the second polarized filter 216 may be incorporated into the windshield of the first vehicle 210. The first vehicle 210 may further include a third polarized filter 220 situated in front of a rear view mirror 218. Additionally, the first vehicle 210 may include a fourth polarized filter 224 situated in front of a side view mirror 222. It shall be understood that there may be such a polarized filter 224 in front of each other side view mirror of the first vehicle 210.

The system 200 further comprises a second vehicle 240 including a headlight 242 and a first polarized filter 244 situated in front of the headlight 242. It shall be understood that there may be such a polarized filter 244 in front of each other headlight of the second vehicle 240. The second vehicle 240 further comprises a second polarized filter 246 situated in front of the driver 258 of the second vehicle 240. In this example, the second polarized filter 246 may be incorporated into the windshield of the second vehicle 240. The second vehicle 240 may further include a third polarized filter 250 situated in front of a rear view mirror 248. Additionally, the second vehicle 240 may include a fourth polarized filter 254 situated in front of a side view mirror 252. It shall be understood that there may be such a polarized filter 254 in front of each other side view mirror of the second vehicle 240.

In this case, the first polarized filter 214 of the first vehicle 210 is configured to polarize the light emanating from the headlight 212 in a substantially +90 degree orientation (i.e., horizontal polarization). The second polarized filter 216 of the first vehicle 210 (as well as the third and fourth polarized filters 220 and 224) is configured to polarize the incident light towards the driver 228 in a substantially zero (0) degree orientation (i.e., vertical polarization). Similarly, the first polarized filter 244 of the second vehicle 240 is configured to polarize the light emanating from the headlight 242 in a substantially +90 degree orientation (i.e., horizontal polarization). The second polarized filter 246 (as well as the third and fourth polarized filters 248 and 254) of the second vehicle 240 is configured to polarize the incident light towards the driver 258 in a substantially zero (0) degree manner (i.e., vertical polarization).

From the perspective of the driver 228 of the first vehicle 210, the light 256 emanating from the headlight 242 of the second vehicle 240 is polarized in the substantially −90 degree orientation (i.e., horizontal polarization). The second polarized filter 216 in front of the driver 228 of the first vehicle 210, being substantially vertically polarized, blocks substantially most of the light 256 emanating from the second vehicle 240. The reason for this is that the polarization of the second polarized filter 216 of the first vehicle 210 is substantially orthogonal to that of the incident light 256 emanating from the second vehicle 240. The third and fourth polarized filters 220 and 224 also perform such filtering of light emanating from tailing vehicles. Thus, the exemplary vehicle glare reduction system 200 provides protection against glare emanating from on-coming and tailing vehicles.

In contrast to the prior art vehicle glare reduction system 100, the vehicle glare reduction system 200 in accordance with the invention does provide protection against glare emanating from the driver's own vehicle. For example, from the perspective of the driver 228 of the first vehicle 210, the light 226a emanating from the headlight 212 by way of the polarized filter 214 is polarized in a substantially +90 degree orientation (i.e., horizontal polarization). When that light 226a strikes a reflective object 230, the reflected light 226b is also polarized in a substantially +90 degree orientation. In other words, the polarization of the incident light and the reflected light are substantially the same. In this case, the polarized filter 216 in front of the driver 228 does significantly block the reflected light 226b since their respective polarizations are substantially orthogonal to each other. Thus, the exemplary vehicle glare reduction system 200 provides protection against glare emanating from its own vehicle headlights.

FIG. 2B illustrates a block diagram of an exemplary vehicle glare reduction control system 260 in accordance with another embodiment of the invention. The vehicle glare reduction control system 260 comprises a processor 262, a memory 264, a headlight active polarizing filter 266, and an ambient light sensor 268. The processor 262 performs the various operations of the vehicle glare reduction control system 260 as discussed below, the headlight active polarizing filter 266 polarizes the light emanated by the vehicle headlight under the control of the processor 262, the ambient light sensor 268 generates a signal related to the intensity of the ambient light, and the memory 264, serving generally as a computer readable medium, stores one or more software modules adapted to control the processor 262 in performing its intended operations.

In operation, the processor 262, under the control of the software module(s) stored in the memory 264, periodically reads the signal generated by the ambient light sensor 268. Based on that signal, the processor 262 controls the headlight active polarizing filter 266. For example, if the signal generated by the ambient light sensor 268 indicates that the intensity of the ambient light is below a predetermined light intensity threshold (e.g., during twilight or night time), the processor 262 may control the headlight active polarizing filter 266 to polarize the light emanating from the vehicle headlight in a first polarization orientation (e.g., substantially horizontal orientation). If, on the other hand, the signal generated by the ambient light sensor 268 indicates that the intensity of the ambient light is above a predetermined light intensity threshold (e.g., during day time), the processor 262 may control the headlight active polarizing filter 266 to polarize the light emanating from the vehicle headlight in a second polarization orientation (e.g., substantially vertical orientation).

Alternatively, the processor 262 may control the headlight active polarizing filter 266 to provide varying degree of polarization of the light emanating from the vehicle headlight dependent upon the signal generated by the ambient light sensor 268. For example, if the signal generated by the ambient light sensor 268 indicates that the intensity of the ambient light is at X1-amount of Lumens, the processor 262 may control the headlight active polarizing filter 266 to polarize the light emanating from the vehicle headlight by Y1-amount degrees. Similarly, if the signal generated by the ambient light sensor 268 indicates that the intensity of the ambient light is at X2-amount of Lumens, the processor 262 may control the headlight active polarizing filter 266 to polarize the light emanating from the vehicle headlight by Y2-amount degrees. The processor 262 may perform the translation from light intensity to degree-of-polarization using an equation or algorithm implemented by the software module(s) or by a look-up table stored in the memory 264.

FIG. 2C illustrates a block diagram of another exemplary vehicle glare reduction control system 270 in accordance with another embodiment of the invention. The vehicle glare reduction control system 270 comprises a processor 272, a memory 274, a windshield active polarizing filter 276, and an ambient light sensor 278. The processor 272 performs the various operations of the vehicle glare reduction control system 270 as discussed below, the windshield active polarizing filter 276 filters polarized light incident upon the windshield under the control of the processor 272, the ambient light sensor 278 generates a signal related to the intensity of the ambient light, and the memory 264, serving generally as a computer readable medium, may store one or more software modules to control the processor 272 in performing its intended operations.

In operation, the processor 272, under the control of the software module(s) stored in the memory 274, periodically reads the signal generated by the ambient light sensor 278. Based on that signal, the processor 272 controls the windshield active polarizing filter 276. For example, if the signal generated by the ambient light sensor 278 indicates that the intensity of the ambient light is below a predetermined light intensity threshold (e.g., during twilight or night time), the processor 272 may control the headlight active polarizing filter 276 to provide polarized filtering of the exterior light incident upon the windshield in a first polarization orientation (e.g., substantially horizontal orientation). If, on the other hand, the signal generated by the ambient light sensor 278 indicates that the intensity of the ambient light is above a predetermined threshold (e.g., during day time), the processor 272 may control the windshield active polarizing filter 276 to provide polarized filtering of the exterior light incident upon the windshield in a second polarization orientation (e.g., substantially vertical orientation).

Alternatively, the processor 272 may control the windshield active polarizing filter 276 to provide varying degree of polarized filtering of the light incident upon the windshield dependent upon the signal generated by the ambient light sensor 278. For example, if the signal generated by the ambient light sensor 278 indicates that the intensity of the ambient light is at X1-amount of Lumens, the processor 272 may control the windshield active polarizing filter 276 to provide a Y1-amount degree of polarized filtering of the light incident upon the windshield. Similarly, if the signal generated by the ambient light sensor 278 indicates that the intensity of the ambient light is at X2-amount of Lumens, the processor 262 may control the windshield active polarizing filter 276 to provide a Y2-amount degree of polarized filtering of the light incident upon the windshield. The processor 272 may perform the translation from light intensity to degree-of-polarization using an equation or algorithm implemented by the software module(s) or by a look-up table stored in the memory 272.

II. Roadway Selective Light Transmission System

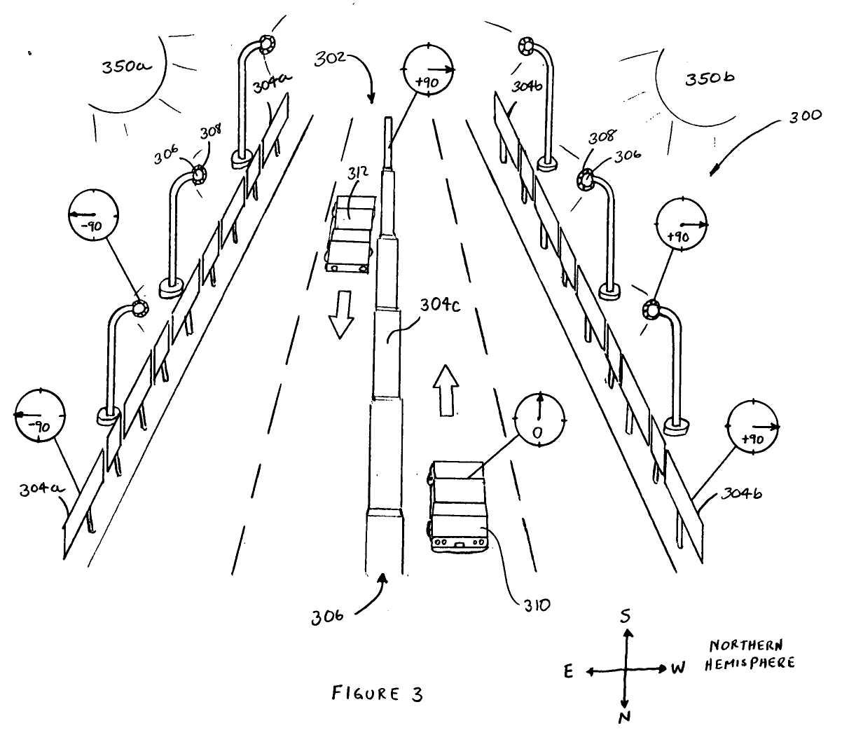

FIG. 3 illustrates a perspective view of an exemplary roadway glare reduction system 300 in accordance with another embodiment of the invention. The roadway glare reduction system 300 comprises a road 302. In this example, the road 302 is a two-way road. However, it shall be understood that the road 302 may also be a one-way road. Also, in this example, the road 302 is situated in the northern hemisphere and runs generally north-south, with the south-direction towards the top of the drawing. Again, the orientation and location of the road 302 is only illustrative. In this orientation, the morning Sun 350a is situated on the eastward side of the road 302, and the evening Sun 350b is situated on the westward side of the road 302.

The roadway glare reduction system 300 further comprises a plurality of polarized filter panels (e.g., Plexiglas) 304a and 304b situated respectively along the eastward and westward sides of the road 302. The roadway glare reduction system 300 further comprises a center divider 306 dividing the south-bound from the north-bound of the road 302. The roadway glare reduction system 300 includes a plurality of polarized filter panels 304c situated along the center divider 306 of the road 302. Additionally, the roadway glare reduction system 300 includes a plurality of roadway lights 306 including polarizing filters 308 situated along both sides of the road 302.

With regard to daylight glare protection, the eastward polarized filter panels 304a are configured to provide glare protection against the sunlight emanating from the morning Sun 350a. For example, the polarized filter panels 304a may be configured substantially adjacent to each other and oriented substantially parallel to the road 302. In this example, the polarized filter panels 304a polarize the sunlight in a substantially horizontal orientation (e.g., −90 degrees). Similarly, the westward polarized filter panels 304b are configured to provide glare protection against the sunlight emanating from the evening Sun 350b. For example, the polarized filter panels 304b may be configured substantially adjacent to each other and oriented substantially parallel to the road 302. In this example, the polarized filter panels 304b polarize the sunlight in a substantially horizontal orientation (e.g., +90 degrees).

With regard to nightlight glare protection, the polarized filter panels 304c are configured to provide glare protection against vehicles heading in the opposite direction on the opposite side of the road 302. For example, the polarized filter panels 304c may be configured to protect the driver of the south-bound vehicle 310 against the light emanating from the north-bound vehicle 312. Such configuration of the polarized filter panels 304c also protects the driver of the north-bound vehicle 312 against the light emanating from the south-bound vehicle 310. In this example, the polarized filter panels 304c polarize the vehicle lights in a substantially horizontal orientation (e.g., +90 degrees). In addition, the polarized filters 308 associated with roadway lights 306 are also polarized in a substantially horizontal orientation to reduce glare.

In the morning during sunrise, the eastward polarized filter panels 304a polarize the sunlight emanating from the morning Sun 350a and towards the south-bound vehicle 310 in a substantially horizontal orientation. As discussed above, the windshield of the vehicle 310 may be configured as a substantially vertical polarizing filter. Since the polarization of the sunlight directed at the vehicle 310 is substantially orthogonal to the polarization of the windshield of the vehicle 310, the windshield polarizing filter of the vehicle 310 protects its driver against glare resulting from the morning Sun 350a. The eastward polarized panels 304a in combination with the polarizing filters on the mirrors of the North-bound vehicle 312 may also provide glare protection for the driver of the North-bound vehicle 312.

In the evening during sunset, the westward polarized filter panels 304b polarize the sunlight emanating from the evening Sun 350b and towards the south-bound vehicle 310 in a substantially horizontal orientation. As discussed above, the windshield of the vehicle 310 may be configured as a substantially vertical polarizing filter. Since the polarization of the sunlight directed at the vehicle 310 is substantially orthogonal to the polarization of the windshield of the vehicle 310, the windshield polarizing filter of the vehicle 310 protects its driver against glare resulting from the evening Sun 350b. The center divider polarized panels 304c in combination with the polarizing filters on the mirrors of the North-bound vehicle 312 may also provide glare protection for the driver of the North-bound vehicle 312.

At night after the Sun has set, the polarized filter panels 304c situated along the center divider 306 of the road 302 protect drivers against glare emanating from on-coming vehicles. For example, the light emanating from the headlights of the north-bound vehicle 312 toward the south-bound vehicle 310 is polarized in a substantially horizontal orientation by the center divider polarized filter panels 304c. As discussed above, the windshield of the vehicle 310 may be configured as a substantially vertical polarizing filter. Since the polarization of the light from the on-coming vehicle 312 is now substantially orthogonal to the polarization of the windshield of the vehicle 310, the windshield polarizing filter of the vehicle 310 protects its driver against such glare.

Similarly, the light emanating from the roadway lights 306 is now polarized in a substantially horizontal orientation by the polarized filters 308. As discussed above, the windshield of the vehicle 310 may be configured as a substantially vertical polarizing filter. Since the polarization of the light from the roadway lights 306 is now substantially orthogonal to the polarization of the windshield of the vehicle 310, the windshield polarizing filter of the vehicle 310 protects its driver against such glare.

III. Camera Glare Reduction System

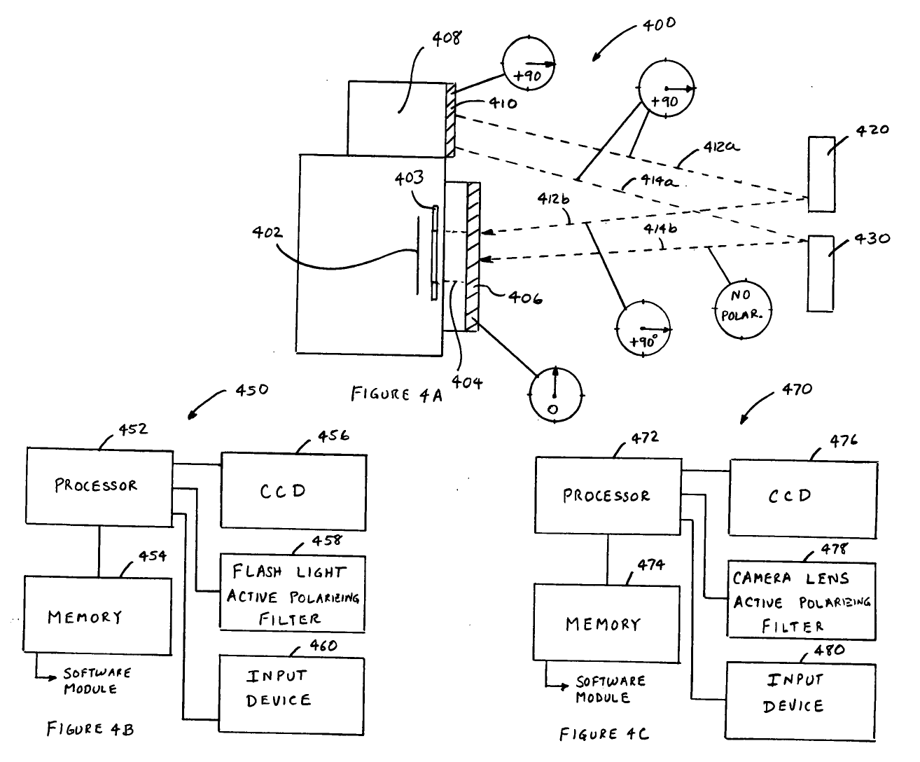

FIG. 4A illustrates a side view of an exemplary camera glare reduction system 400 in accordance with another embodiment of the invention. The camera glare reduction system 400 comprises a light-sensitive device 402 (e.g., a film or a charged coupled device (CCD)), a shutter 403, a lens 404, a flash light source 408, a first polarized filter 410, and a second polarized filter 406. The first polarized filter 410 polarizes the light emanating from the flash light source 408 in a substantially horizontal orientation (e.g., +90 degrees). The second polarized filter 406 performs substantially vertical (e.g., zero (0) degree) polarized filtering of the incident light towards the camera lens 404. As explained below, such camera glare reduction system 400 reduces glare attributed to the flash light source 408.

During a flash light event, the light 412a and 412b emanating from the flash light source 408 get polarized in a substantially horizontal orientation (e.g., +90 degrees). In this example, the light 412a strikes a substantially reflective object 420. As discussed above, the polarization of the reflected light 412b remains substantially the same; in this case remains substantially horizontally polarized. Also, as discussed above, the polarization of the second polarized filter 406 is substantially vertical (e.g., 0 degree). Accordingly, since the polarization of the light 412b reflecting off the reflective object 420 is substantially orthogonal to the polarization of the second polarized filter 406, the filter 406 substantially blocks the light 412b. Thus, the camera glare reduction system 400 substantially reduces light reflecting off of substantially reflective objects, which is often undesirable in pictures.

On the other hand, light reflecting off of substantially non-reflective objects is able to propagate through the filter 406. For example, in this case the substantially horizontally polarized light 414a strikes a generally non-reflective object 430. The light 414b reflecting off the generally non-reflective object 430 loses its polarization. Accordingly, the second polarized filter 406 allows such light 414b to pass through the lens 404 and shutter 403 and finally to the light sensitive device 402. Thus, in addition to reducing unwanted light reflecting off of substantially reflective objects, the camera glare reduction system 400 allows the capture of light off generally non-reflective objects, which is often desirable in pictures. Although a still-picture camera is used to exemplify the invention, it shall be understood that the invention is also applicable to video cameras where the light source 408 is continuously illuminating.

In addition to reducing unwanted glare, the camera system 400 may also be capable of reducing “red eye” typically reflecting off the back of a person's eye. If, for example, such a person wears eyewear such as glasses or contacts that are polarized in a substantially vertical orientation, the light emanating from the flash light 408, being polarized in a substantially horizontal orientation, does not significantly pass through the eyewear. Therefore, light reflection off the back of a person's eye is substantially reduced, thereby reducing “red eye”.

FIG. 4B illustrates a block diagram of an exemplary camera glare reduction control system 450 in accordance with another embodiment of the invention. The camera glare reduction control system 450 comprises a processor 452, a memory 454, a CCD device 456, a flash light active polarizing filter 458, and an input device 460. The processor 452 performs the various operations of the camera glare reduction control system 450 as discussed below, the CCD 456 captures the light image being received, the flash light active polarizing filter 458 polarizes the light emanating from a flash light source under the control of the processor 452, the input device 460 allows a user of the system 450 to provide instructions to the processor 452 such as the polarization orientation with which to set the flash light active polarizing filter 458, and the memory 460, serving generally as a computer readable medium, stores one or more software modules adapted to control the processor 452 in performing its intended operations.

In operation, the processor 452 receives a signal from the input device 460 indicating a desired polarization orientation for the flash light active polarizing filter 458. For example, a user using the input device 460 may instruct the processor 452 to set up the flash light active polarizing filter 458 for a desired polarization orientation of +35 degrees. In response to such input, the processor 452 then sends a control signal to the flash light active polarizing filter 458 to set it up for the desired polarization.

The polarization of the flash light and subsequent filtering of the received light as discussed above may affect the desired image being received. For instance, such polarization and filtering may add a shade of gray to the image being received. To address this issue, the processor 452 may perform image processing to correct for any distortion to the image being received as a result of the polarization and subsequent filtering, or to perform any other type of image processing. The processor 452 may perform this image processing by an equation or algorithm implemented by the software module(s) or by a look-up table stored in the memory 454.

FIG. 4C illustrates a block diagram of another exemplary camera glare reduction control system 470 in accordance with another embodiment of the invention. The camera glare reduction control system 470 comprises a processor 472, a memory 474, a CCD device 476, a camera lens active polarizing filter 478, and an input device 480. The processor 472 performs the various operations of the camera glare reduction control system 470 as discussed below, the CCD 476 captures the light image being received, the camera lens active polarizing filter 478 performs polarized filtering of the incident light received under the control of the processor 472, the input device 480 allows a user of the system 470 to provide instructions to the processor 472 such as the polarization orientation with which to set the camera lens active polarizing filter 478, and the memory 480, serving generally as a computer readable medium, stores one or more software modules adapted to control the processor 472 in performing its intended operations.

In operation, the processor 472 receives a signal from the input device 480 indicating a desired polarization orientation for the camera lens active polarizing filter 478. For example, a user using the input device 480 may instruct the processor 472 to set up the camera lens active polarizing filter 478 for a desired polarization orientation of −67 degrees. In response to such input, the processor 472 then sends a control signal to the camera lens active polarizing filter 478 to set it up for the desired polarization.

The polarization of the flash light and subsequent filtering of the received light as discussed above may affect the desired image being received. For instance, such polarization and filtering may add a shade of gray to the image being received. To address this issue, the processor 472 may perform image processing to correct for any distortion to the image being received as a result of the polarization and subsequent filtering, or to perform any other type of image processing. The processor 472 may perform this image processing by an equation or algorithm implemented by the software module(s) or by a look-up table stored in the memory 474.

IV. Microscope Glare Reduction System

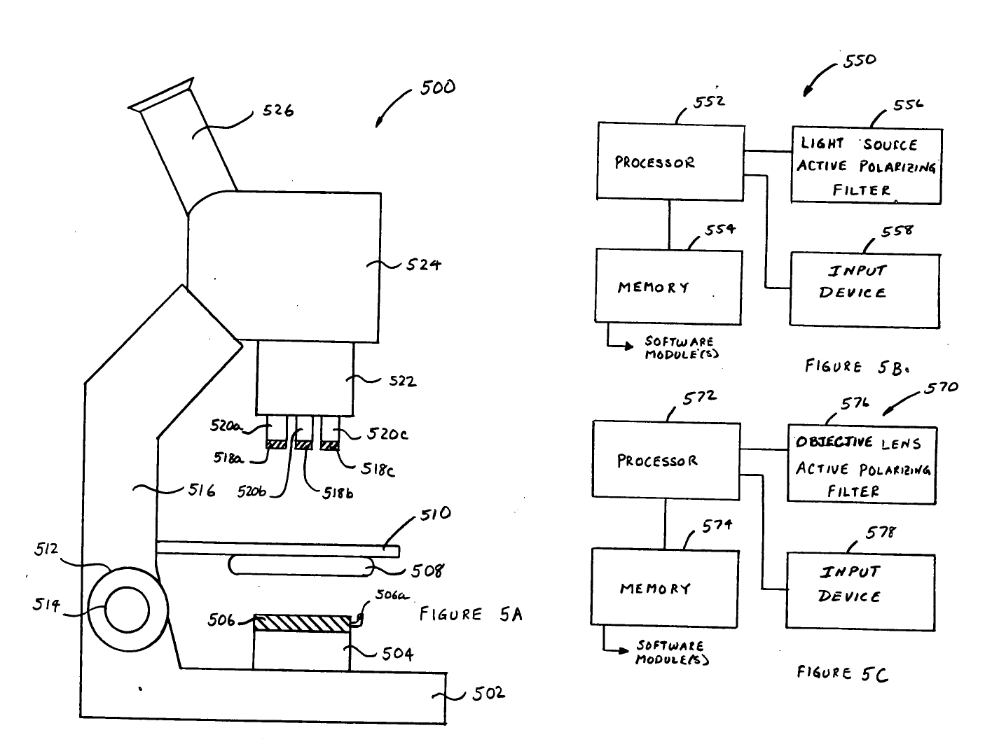

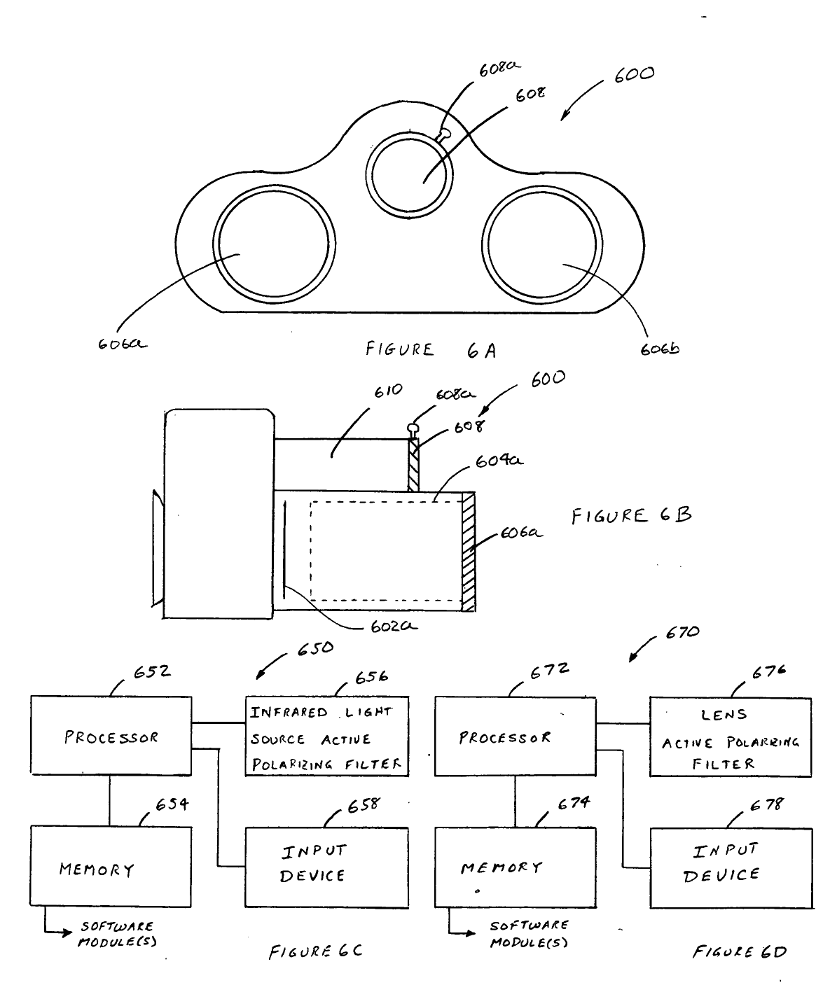

FIG. 5A illustrates a side view of an exemplary microscope glare reduction system 500 in accordance with another embodiment of the invention. The microscope glare reduction system 500 comprises a base 502, a light source disposed on top of the base 502, and a first polarized filter 506 including a mechanical adjust 506a disposed on top of the light source 504. The microscope system 500 further comprises an arm 516 connected to and extending upwards from the base 502. A coarse focus control knob 512 and a fine focus control knob 514 are disposed on a side of the arm 516. The microscope system 500 further comprises a stage 510 extending laterally from the arm 516 and situated above the first polarized filter 506. A diaphragm 508 is connected to the bottom of the stage 510.

The microscope glare reduction system 500 further comprises a housing 524 for enclosing a real image device. The housing 524 is supported on the upper end of the arm 516. A rotatable housing 522 is rotatably coupled to the bottom the real image device housing 524. A plurality of objective lens 520a, 520b, and 520c are connected to the bottom of the rotatable housing 522. A plurality of secondary polarized filters 518a, 518b, and 518c are connected to the bottoms of the objective lens 520a, 520b, and 520c, respectively. An eyepiece 526 is disposed near the upper portion of the real image device housing 524.

The microscope glare reduction system 500 is capable of reducing glare and light interference emanating from the light produced by the light source 504. The first polarized filter 506 polarizes the light emanating from the light source 504 in a desired polarization based upon setting of the mechanical adjust 506a. For example, a user may view the specimen disposed on the stage 510 using the eye piece 526 and adjust the polarization of the first polarized filter 506 to obtain a desired image of the specimen. The secondary polarized filters 518a, 518b, and 518c may be polarized in a fixed manner (e.g., substantially vertical polarization), and function to block some of the incident polarized light emanating from the light source 504 through the first polarized filter 506.

FIG. 5B illustrates a block diagram of an exemplary microscope glare reduction control system 550 in accordance with another embodiment of the invention. The microscope glare reduction control system 550 comprises a processor 552, a memory 554, a light source active polarizing filter 556, and an input device 558. The processor 552 performs the various operations of the microscope glare reduction control system 550 as discussed below, the light source active polarizing filter 558 polarizes the light emanating from the microscope light source under the control of the processor 552, the input device 558 allows a user of the system 550 to provide instructions to the processor 552 such as the polarization orientation with which to set the light source active polarizing filter 556, and the memory 554, serving generally as a computer readable medium, stores one or more software modules adapted to control the processor 552 in performing its intended operations.

In operation, the processor 552 receives a signal from the input device 558 indicating a desired polarization orientation for the light source active polarizing filter 556. For example, a user using the input device 558 may instruct the processor 552 to set up the light source active polarizing filter 556 for a desired polarization orientation of −15 degrees. In response to such input, the processor 552 then sends a control signal to the light source active polarizing filter 556 to set it up for the desired polarization.

FIG. 5C illustrates a block diagram of another exemplary microscope selective light transmission control system 570 in accordance with another embodiment of the invention. The microscope glare reduction control system 570 comprises a processor 572, a memory 574, an objective lens active polarizing filter 576, and an input device 578. The processor 572 performs the various operations of the microscope glare reduction control system 570 as discussed below, the objective lens active polarizing filter 576 performs polarization filtering of the incident light received from the microscope light source under the control of the processor 572, the input device 578 allows a user of the system 550 to provide instructions to the processor 572 such as the polarization orientation with which to set the objective lens active polarizing filter 576, and the memory 574, serving generally as a computer readable medium, stores one or more software modules adapted to control the processor 572 in performing its intended operations.

In operation, the processor 572 receives a signal from the input device 578 indicating a desired polarization orientation for the objective lens active polarizing filter 576. For example, a user using the input device 578 may instruct the processor 572 to set up the objective lens active polarizing filter 576 for a desired polarization orientation of +75 degrees. In response to such input, the processor 572 then sends a control signal to the objective lens active polarizing filter 578 to set it up for the desired polarization.

V. Night-Vision Binocular Glare Reduction Transmission System

FIG. 6A illustrates a side view of an exemplary night-vision binocular glare reduction system 600 in accordance with another embodiment of the invention. The night-vision binocular glare reduction system 600 comprises right and left infrared sensors (right sensor shown as 602a), right and left lenses (right lens shown as 604a), right and left polarized filters 606a and 606b, an infrared light source polarized filter 608 including a mechanical adjust, and an infrared light source 610. The polarized filter 608 polarizes the infrared light emanating from the infrared light source 610 in a substantially horizontal orientation (e.g., +90 degrees). The right and left polarized filters 606a and 606b perform substantially vertical (e.g., zero (0) degree) polarized filtering of the infrared light incident upon the filters 606a and 606b. Thus, the night-vision binocular glare reduction system 600 reduces glare present in the received infrared light.

FIG. 6B illustrates a block diagram of an exemplary night-vision binocular glare reduction control system 650 in accordance with another embodiment of the invention. The night-vision binocular glare reduction control system 650 comprises a processor 652, a memory 654, an infrared light source active polarizing filter 656, and an input device 658. The processor 652 performs the various operations of the night-vision binocular glare reduction control system 650 as discussed below, the infrared light source active polarizing filter 656 polarizes the infrared light emanating from the infrared light source under the control of the processor 652, the input device 658 allows a user of the system 650 to provide instructions to the processor 652 such as the polarization orientation with which to set the infrared light source active polarizing filter 656, and the memory 654, serving generally as a computer readable medium, stores one or more software modules adapted to control the processor 652 in performing its intended operations.

In operation, the processor 652 receives a signal from the input device 658 indicating a desired polarization orientation for the infrared light source active polarizing filter 656. For example, a user using the input device 658 may instruct the processor 652 to set up the infrared light source active polarizing filter 656 for a desired polarization orientation of +30 degrees. In response to such input, the processor 652 then sends a control signal to the infrared light source active polarizing filter 656 to set it up for the desired polarization.

FIG. 6C illustrates a block diagram of an exemplary night-vision binocular glare reduction control system 670 in accordance with another embodiment of the invention. The night-vision binocular glare reduction control system 670 comprises a processor 672, a memory 674, a lens active polarizing filter 656, and an input device 678. The processor 672 performs the various operations of the night-vision binocular glare reduction control system 670 as discussed below, the lens active polarizing filter 676 polarizes the incident infrared light received under the control of the processor 672, the input device 678 allows a user of the system 670 to provide instructions to the processor 672 such as the polarization orientation with which to set the lens active polarizing filter 676, and the memory 674, serving generally as a computer readable medium, stores one or more software modules adapted to control the processor 672 in performing its intended operations.

In operation, the processor 672 receives a signal from the input device 678 indicating a desired polarization orientation for the lens active polarizing filter 676. For example, a user using the input device 678 may instruct the processor 672 to set up the lens active polarizing filter 676 for a desired polarization orientation of −50 degrees. In response to such input, the processor 672 then sends a control signal to the lens active polarizing filter 676 to set it up for the desired polarization.

VI. Hard Hat Selective Glare Reduction System

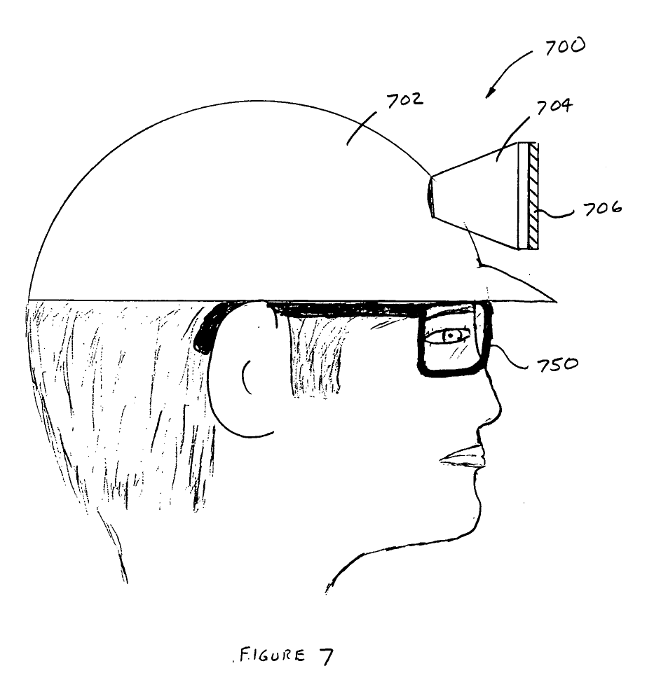

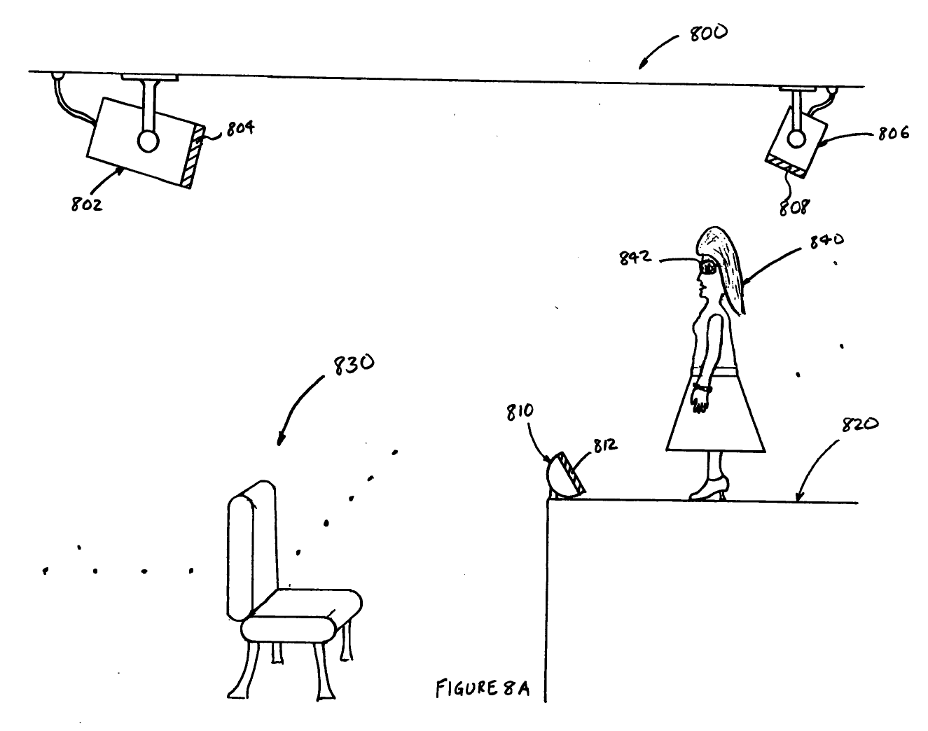

FIG. 7 illustrates a side view of an exemplary hard hat glare reduction system 700 in accordance with another embodiment of the invention. The hard hat glare reduction system 700 comprises a hard hat 702, a light source 704 attached to the hard hat 702, a light source polarizing filter 706 attached to the front of the light source 704, and a polarized eye wear 750 (e.g., goggles, glasses, etc.). The polarized eye wear 750 may be attached to the hard hat 702 or may be separate therefrom. In this example, the light source polarizing filter 706 may be polarized in a substantially horizontal orientation (e.g., +90 degrees), and the polarized eye wear 750 may perform substantially vertical polarization filtering of the received light. Accordingly, the hard hat glare reduction system 700 is capable of reducing glare, which may be advantageous when a construction worker is working around many reflective objects.

VII. Performance Stage Lighting System

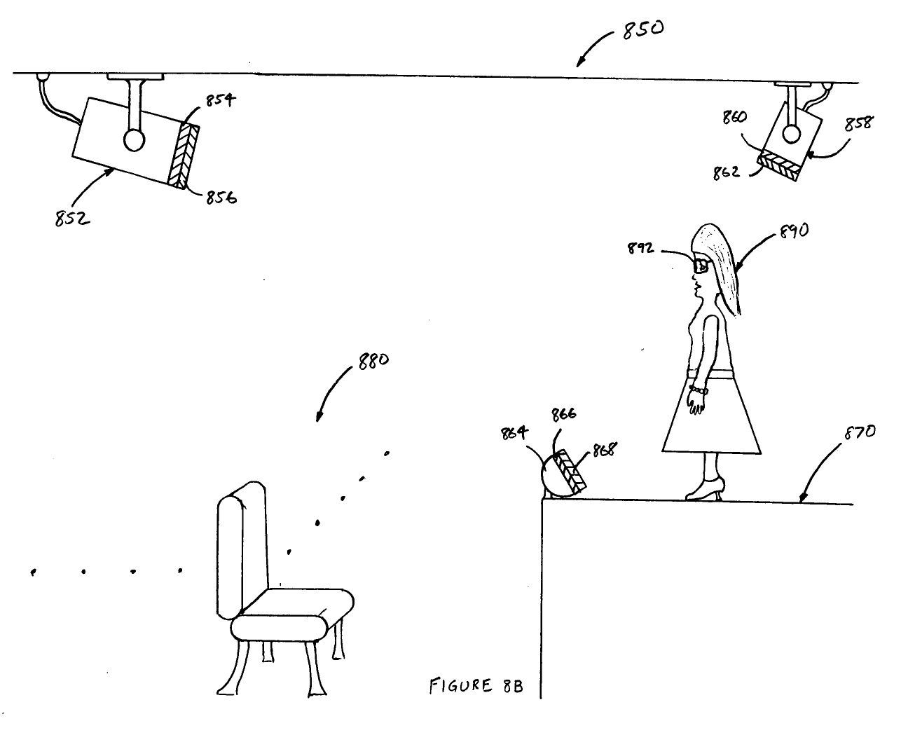

FIG. 8A illustrates a side view of an exemplary performing stage lighting system 800 in accordance with an embodiment of the invention. The stage lighting system 800 comprises a front stage ceiling light source 802 including a polarized filter 804, a rear stage ceiling light source 806 including a polarized filter 808, and a stage floor light source 810 including polarized filter 812. The front stage ceiling light source 802 including its polarized filter 804 may be situated above and proximate a seating area 830 and directs polarized light towards a stage 820. The rear stage ceiling light source 806 including its polarized filter 804 may be situated above and proximate the rear of the stage 820, and directs polarized light towards the stage 820. The stage floor light source 810 including the polarized filter 812 may be attached to the front floor portion of the stage 820, and directs polarized light upwardly towards the rear of the stage 820.

In this example, the polarized filters 804, 808, and 812 polarizes the light emanating from the respective light sources 802, 806, and 808 in a substantially horizontal orientation (e.g., −90 degrees). A performer 840 may wear polarized eye wear 842 that performs polarized filtering in a substantially vertical orientation. In this way, the performing stage lighting system 800 is capable of reducing glare for the performer 840.

FIG. 8B illustrates a side view of an exemplary performing stage lighting system 850 in accordance with another embodiment of the invention. The stage lighting system 850 comprises a front stage ceiling light source 852 including a first polarized filter 854 and a second polarized filter 856, a rear stage ceiling light source 858 including a first polarized filter 860 and a second polarized filter 862, and a stage floor light source 864 including a first polarized filter 866 and a second polarized filter 868. The front stage ceiling light source 852 including its polarized filters 854 and 856 may be situated above and proximate a seating area 880 and directs polarized light towards a stage 870. The rear stage ceiling light source 858 including its polarized filters 860 and 862 may be situated above and proximate the rear of the stage 870, and directs polarized light towards the stage 870. The stage floor light source 864 including its polarized filters 866 and 868 may be attached to the front floor portion of the stage 870, and directs polarized light upwardly towards the rear of the stage 870.

In this example, the first polarized filters 854, 860, and 866 polarizes the light emanating from the respective light sources 852, 858 and 864 by a relatively small positive angle from the horizontal orientation (e.g., +105 degrees). The first polarized filters 856, 862, and 868 polarizes the light emanating from the respective light sources 852, 858 and 864 by a relatively small negative angle from the horizontal orientation (e.g., +75 degrees). A performer 890 may wear polarized eye wear 892 that performs polarized filtering in a substantially vertical orientation. In such a case, a performer 890 may be able to tile his/her head ±15 degrees off the vertical axis and still obtain protection from unwanted glare generated by the stage light sources.

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

I claim:

1. A vehicle glare reduction system, comprising:
a light source;
a first polarized filter adapted to polarize light emanating from said light source in a first orientation, wherein said first orientation is substantially horizontal or vertical; and
a second polarized filter situated in front of a driver viewing area and adapted to perform polarize filtering of incoming light in a second orientation substantially orthogonal to said first orientation.

2. The vehicle glare reduction system of claim 1, wherein said light source comprises a headlight of a vehicle.

3. The vehicle glare reduction system of claim 1, wherein said first orientation of said first polarized filter is substantially horizontal and said second orientation of said second polarized filter is substantially vertical.

4. The vehicle glare reduction system of claim 1, wherein said second polarized filter is incorporated into a windshield of a vehicle.

5. The vehicle glare reduction system of claim 1, wherein said second polarized filter is situated in front of a rear view mirror.

6. The vehicle glare reduction system of claim 1, wherein said second polarized filter is situated in front of a side view mirror.

7. The vehicle glare reduction system of claim 1, wherein said first polarized filter comprises an active polarized filter.

8. The vehicle reduction system of claim 7, further comprising:
an ambient light sensor; and
a processor adapted to control said active polarized filter in response to a signal generated by said ambient light sensor.

9. The vehicle glare reduction system of claim 8, further comprising a computer readable medium including one or more software modules adapted to control said processor in controlling said active polarized filter in response to said signal generated by said ambient light sensor.

10. The vehicle glare reduction system of claim 1, wherein said second polarized filter comprises an active polarized filter.

11. The vehicle glare reduction system of claim 10, further comprising:
an ambient light sensor; and
a processor adapted to control said active polarized filter in response to a signal generated by said ambient light sensor.

12. The vehicle glare reduction system of claim 11, further comprising a computer readable medium including one or more software modules adapted to control said processor in controlling said active polarized filter in response to said signal generated by said ambient light sensor.

13. A roadway glare reduction system, comprising:
a road; and
a plurality of polarized filter panels situated along said road and configured to polarize light emanating from the Sun and/or other light sources.

14. The roadway glare reduction system of claim 13, wherein said polarized filter panels are situated adjacent to each other along a side of said road.

15. The roadway glare reduction system of claim 13, wherein said road comprises a two-way road, and wherein said polarized filter panels are situated adjacent to each other along a center divider of said two-way road.

16. The roadway glare reduction system of claim 13, wherein a polarization of said polarized filter panels is in a substantially horizontal orientation.

17. The roadway glare reduction system of claim 13, further comprising a plurality of roadway lights situated along said road, wherein said roadway lights respectively comprise polarized filters adapted to polarize light emanating from respective said roadway lights.

18. The roadway glare reduction system of claim 17, wherein a polarization of said polarized filters is in a substantially horizontal orientation.

19. A roadway glare reduction system, comprising:
a road; and
a plurality of roadway lights for lighting said road, wherein said roadway lights respectively comprise polarized filters adapted to polarize light emanating from respective said roadway lights.

20. A camera or video system, comprising:
a light source;
a first polarized filter configured to polarize light emanating from said light source;
a second polarized filter adapted to perform polarized filtering on a received light; and
a light sensitive device adapted to receive said filtered light.

21. The camera or video system of claim 20, wherein said light source comprises a flash light.

22. The camera or video system of claim 20, wherein a first polarization of said first polarized filter is substantially orthogonal to a second polarization of said second polarized filter.

23. The camera or video system of claim 20, wherein said light sensitive device comprises a film.

24. The camera or video system of claim 20, wherein said light sensitive device comprises a charged coupled device (CCD).

25. The camera or video system of claim 20, wherein said first polarized filter comprises an active polarized filter.

26. The camera or video system of claim 25, further comprising:
an input device; and
a processor adapted to control said active polarized filter in response to a signal generated by said input device.

27. The camera or video system of claim 26, further comprising a computer readable medium including one or more software modules adapted to control said processor in controlling said active polarized filter in response to said signal generated by said input device.

28. The camera or video system of claim 20, wherein said second polarized filter comprises an active polarized filter.

29. The camera or video system of claim 28, further comprising:
an input device; and
a processor adapted to control said active polarized filter in response to a signal generated by said input device.

30. The camera or video system of claim 29, further comprising a computer readable medium including one or more software modules adapted to control said processor in controlling said active polarized filter in response to said signal generated by said input device.

31. The camera or video system of claim 20, further comprising a processor adapted to perform image processing of image information generated by said light sensitive device from said filtered light.

32. A microscope system, comprising:
a light source;
a first polarized filter configured to polarize light emanating from said light source;
a second polarized filter adapted to perform polarized filtering on a received light; and
an objective lens adapted to receive said filtered light.

33. The microscope system of claim 32, wherein a first polarization of said first polarized filter is substantially orthogonal to a second polarization of said second polarized filter.

34. The microscope system of claim 32, further comprising:
an eye piece optically coupled to said objective lens; and
a stage to support a specimen.

35. The microscope system of claim 32, wherein said first polarized filter comprises an active polarized filter.

36. The microscope system of claim 35, further comprising:
an input device; and
a processor adapted to control said active polarized filter in response to a signal generated by said input device.

37. The microscope system of claim 36, further comprising a computer readable medium including one or more software modules adapted to control said processor in controlling said active polarized filter in response to said signal generated by said input device.

38. The microscope system of claim 32, wherein said second polarized filter comprises an active polarized filter.

39. The microscope system of claim 38, further comprising:
an input device; and
a processor adapted to control said active polarized filter in response to a signal generated by said input device.

40. The microscope system of claim 39, further comprising a computer readable medium including one or more software modules adapted to control said processor in controlling said active polarized filter in response to said signal generated by said input device.

41. A night vision device, comprising:
an infrared light source;
a first polarized filter configured to polarize infrared light emanating from said infrared light source;
a second polarized filter adapted to perform polarized filtering on a received infrared light; and
an infrared light sensitive device adapted to receive said filtered light.

42. The night vision device of claim 41, wherein a first polarization of said first polarized filter is substantially orthogonal to a second polarization of said second polarized filter.

43. The night vision device of claim 41, wherein said first polarized filter comprises an active polarized filter.

44. The night vision device of claim 43, further comprising:
an input device; and
a processor adapted to control said active polarized filter in response to a signal generated by said input device.

45. The night vision device of claim 44, further comprising a computer readable medium including one or more software modules adapted to control said processor in controlling said active polarized filter in response to said signal generated by said input device.

46. The night vision device of claim 41, wherein said second polarized filter comprises an active polarized filter.

47. The night vision device of claim 46, further comprising:
an input device; and
a processor adapted to control said active polarized filter in response to a signal generated by said input device.

48. The night vision device of claim 47, further comprising a computer readable medium including one or more software modules adapted to control said processor in controlling said active polarized filter in response to said signal generated by said input device.

49. A hard hat lighting system comprising:
a hard hat;
a light source attached to said hard hat; and
a first polarized filter adapted to polarize light emanating from said light source.

50. The hard hat lighting system of claim 49, wherein said eye wear is attached to said hard hat.

51. The hard hat lighting system of claim 49 further comprising an eye wear including a second polarized filter adapted to perform polarized filtering of a received light.

52. The hard hat lighting system of claim 51, wherein a first polarization of said first polarized filter is substantially orthogonal to a second polarization of said second polarized filter.

53. A stage lighting system, comprising:
a stage light source; and
a first polarized filter adapted to polarize light emanating from said stage light source.

54. The stage lighting system of claim 53, wherein said first polarized filter is attached to said stage light source.

55. The stage lighting system of claim 53, further comprising a second polarized filter adapted to further polarize light emanating from said stage light source.

56. The stage lighting system of claim 55, wherein said first and second polarized filters are attached to said stage light source.

57. The stage lighting system of claim 55, wherein a first polarization of said first polarized filter is different than a second polarization of said second polarized filter.
